(19) United States
(12) Patent Application Publication
(10) Pub. No.: US 2024/0280751 A1
(43) Pub. Date: Aug. 22, 2024

(54) Subwavelength Grating Based on Bound States in the Continuum Optical Antenna For Optical Phased Array

(71) Applicant: Harbin Institute of Technology, Shenzhen, Shenzhen (CN)

(72) Inventors: Xiaochuan Xu, Shenzhen (CN); Weiming Yao, Shenzhen (CN); Wanchang Gao, Shenzhen (CN); Haoshuai Mou, Shenzhen (CN); Yong Yao, Shenzhen (CN)

(73) Assignee: Harbin Institute of Technology, Shenzhen, Shenzhen (CN)

(21) Appl. No.: 18/616,514

(22) Filed: Mar. 26, 2024

Related U.S. Application Data
(63) Continuation-in-part of application No. 17/168,089, filed on Feb. 4, 2021, now Pat. No. 11,940,560.

(30) Foreign Application Priority Data
Jul. 28, 2020 (CN) 202010736857.5

(51) Int. Cl. G02B 6/124

(52) U.S. Cl. CPC G02B 6/124

(57) ABSTRACT

The invention discloses a subwavelength grating based on bounds state in the continuum as the optical antenna for optical phased array, which includes a substrate and a grating layer atop the substrate. The grating layer includes a strip waveguide and sub-gratings symmetrically arranged on both sides of the strip waveguide. The sub-gratings may also be placed on different layers to build a multi-layer grating. The sub-grating excites the radiation modes, and destructive interference is formed between the sideward radiation modes by adjusting the width of the strip waveguide, which is used to establish the bounds state in the continuum. By designing the grating structure and adjusting the width of the strip waveguide, the invention establishes a diffraction-limited bound state in the continuum between sub-gratings to suppress sideward emission, thereby suppressing crosstalk between gratings, reducing the antenna pitch of the optical phased array, and increasing the phase-tuned beam steering range.

### I. CROSS REFERENCE TO RELATED APPLICATIONS

This application is a continuation-in-part of U.S. patent application Ser. No. 17/168,089, titled “Ultra-Long Subwavelength Grating Based Optical Antenna For Optical Phased Array,” filed on Feb. 4, 2021, which claims the priority benefit of China application serial no. 202010736857.5, filed on Jul. 28, 2020. The entirety of the above-mentioned patent applications are hereby incorporated by reference herein and made a part of this specification.

### II. BACKGROUND

### 1. Technical Field

The invention relates to optical phased arrays, in particular to a subwavelength grating based on bound states in the continuum (BIC) optical antennas for optical phased arrays.

### 2. Description of Related Art

Beam steering technology has a broad application in many fields such as light detection and ranging (LiDAR), free-space optical communication and holographic display. It has received intensive attention in the past decades. Designing a beam steering system with a small diffraction divergence angle, high emission efficiency, large steering range and high steering speed is a goal that has been pursued by those skilled in the art all the time.

With the rapid advancement of large-scale silicon photonic integration technology, optical phased arrays (OPAs) have been studied intensively in recent years for its potential to achieve high stability, compact, and low cost beam steering systems. One-dimensional (1D) optical phased arrays are achieved by controlling the phase difference between adjacent gratings by phase shifters. However, 1D beam steering limits the scope of applications. In order to realize 2D beam steering, the combination of wavelength and phase tuning is an attractive approach. However, because of the high refractive index contrast between silicon and cladding materials on silicon-on-insulator (SOI) and the limited fabrication precision, the perturbations are so strong that the light can only propagate a short length in the grating, leading to the large diffraction divergence angle.

In order to reduce the diffraction divergence angle, the effective length of the grating needs to be increased. Many structure designs have been reported to reduce the grating strength, such as shallow grating, sidewall corrugated grating, multilayer grating, and lower index contrast platform. Shallow grating and sidewall corrugated grating reduce the grating strength by reducing the etching depth. Multilayer grating weaken the influence of gratings on light by separating gratings and waveguides in the vertical direction. For lower index contrast platform, the grating strength is weaken by reducing the effective refractive index difference of grating.

These methods can somewhat increase the grating length but also suffer from their own limitations. Specifically, shallow etched grating and sidewall corrugated grating inevitably increases requirements of the fabrication process; multilayer grating requires double layer fabrication, increasing fabrication complexity and cost; lower index contrast platform such as the Si3N4 requires a wider waveguide to bind the light and it has smaller angular dispersion which limits the steering range with wavelength change. In a word, these methods increase the grating length at the price of increased fabrication complexity and cost.

The research on optical phased array in recent years is mainly based on one-dimensional arrays combined with phase and wavelength tuning, which take waveguide grating antenna array as the transmitting end. In order to enlarge the beam steering range of OPA, the center pitch between the adjacent antennas needs to be reduced. For OPAs with uniform array spacing, only when the antenna pitch is less than half the operating wavelength, can a complete 180° field-of-view (FoV) without aliasing be obtained. Conversely, if the antenna pitch is greater than half the operating wavelength, high-order grating lobes will appear in the far-field pattern, which will cause aliasing and disperse the power from the main lobe. However, reducing the antenna pitch will inevitably increase the crosstalk between adjacent gratings, which will have a great impact on the phase of adjacent gratings and seriously disturb the far field pattern. In addition, the sideward emission of grating structures will further strengthen the crosstalk. The antenna pitch of current OPAs are usually a few microns, which can effectively suppress crosstalk with sacrifice of the FoV. Therefore, research on 1D OPA of suppressing crosstalk as much as possible without increasing the center pitch between adjacent gratings is significant.

In order to suppress crosstalk and achieve high-density integration, the following solutions have been proposed. The first solution is to destroy the phase matching conditions of adjacent waveguides by controlling the refractive index difference of the guided mode. Specifically, this can be achieved through waveguides with different widths, composite equivalent waveguides and curved waveguides, such as superlattice waveguide array, sinusoidal curved waveguide array. The second solution is micro-nano structure design. Based on the research on the optical momentum of evanescent waves, it indicates that if the cladding material is anisotropic, by adjusting the dielectric constant of the material along the direction of light propagation, the optical momentum of evanescent wave can be controlled, and then the attenuation speed of evanescent wave in the cladding material can be regulated. This provides a new technical route for suppressing crosstalk. As long as the attenuation speed of the evanescent wave is accelerated, that is, the skin depth is reduced, crosstalk can be effectively suppressed. Such anisotropic cladding materials are called metamaterials. Actually, metamaterials with approximately the same properties can be constructed through subwavelength micro-nano structures, such as e-skid waveguide array. In addition to the above two solutions, a method based on adiabatic elimination is also proposed. This method can dynamically control the coupling between two tightly packed waveguides on demand by modulating the mode refractive index of the intermediate decoupling waveguide.

Since these solutions focus on suppressing crosstalk between waveguides, they are only applicable to end-emitting OPAs and are not suitable for surface-emitting OPAs. In particular, due to the scheme of grating as the antenna of surface-emitting OPA, the sideward emission of the gratings leads to stronger crosstalk. Some researchers have proposed constructing destructive interference between different diffraction channels to suppress the sideward emission of grating antenna, thus introducing the method of bound states in the continuum for grating design. The regulation of grating emission characteristics by BIC provides a new perspective for suppressing crosstalk of waveguide grating antenna.

### III. SUMMARY

To solve the problems of the prior art, the invention provides an ultra-long subwavelength grating as the optical antenna for optical phased array.

The subwavelength grating comprises a top and a bottom structure which are vertically stacked, wherein the bottom structure is made of a material with a refractive index lower than top structure, such as various oxides. The top structure is made of a material with the refractive index higher than bottom, such as silicon, silicon nitride, aluminum nitride and aluminum oxide. A strip waveguide is formed in the middle of the top structure. Subwavelength blocks are placed within the evanescent field of the strip waveguide to form the grating structure. When the sizes and positions of the subwavelength blocks are selected properly, the effective length of the grating can be greatly increased. By adjusting the size and position of the subwavelength blocks in different periods, uniform or arbitrary shape near field distribution can be generated.

As a further improvement of the invention, the thickness of the strip waveguide and thicknesses of the subwavelength blocks are the same.

As a further improvement of the invention, the width of the central strip waveguide is smaller than 1 μm.

As a further improvement of the invention, the gap between edges of the strip waveguide and edges of the subwavelength blocks is smaller than 1 μm.

As a further improvement of the invention, the subwavelength blocks on the two sides of the strip waveguide are formed symmetrically.

The invention has the following beneficial effects: the subwavelength grating is used to reduce the grating strength to propagating light, so that the effective length of the grating is increased, and thus the diffraction divergence angle is reduced. The near-field distribution of the field can be controlled by means of the structures arrayed at unequal intervals. The structure is simpler with lower fabrication requirements and lower cost.

To solve the problems of the prior art, the invention provides a subwavelength grating based on bound states in the continuum as the optical antenna for optical phased array. The sideward emission of this grating can be suppressed by constructing BIC, thereby suppressing crosstalk between adjacent gratings. Compared with other solutions, its structure is simpler and has lower process requirements. Applying this grating to an OPA can reduce the antenna pitch, thereby increasing the field-of-view and suppressing far-field spot splitting due to strong sideward emission, thereby improving the performance of the OPA.

The invention proposes a subwavelength BIC-based grating, comprising a substrate and a grating layer installed on the substrate. The grating layer includes a strip waveguide and sub-gratings symmetrically arranged on both sides of the strip waveguide. As an extension, the sub-gratings can also be placed on different layers to build a multi-layer grating. The sub-grating excites the radiation modes, and destructive interference is formed between the sideward radiation modes by adjusting the width of the strip waveguide, which is used to establish the BIC.

As a further improvement of the invention, the BIC is established by adjusting the width of the strip waveguide. Specifically, the width of the strip waveguide cooperates with the radiation modes excited by sub-gratings, and destructive interference is established between the sideward radiation modes, so that the proportion of the intensity emitted sideward to the intensity emitted by the grating as a whole is less than 0.1.

As a further improvement of the invention, the three-dimensional shape of the sub-grating is one or more of a rectangular cuboid, a cube, a cylinder, and an elliptical cylinder, and the sub-gratings on the same side are periodically arranged. The thicknesses of the sub-gratings and the strip waveguide are the same.

As a further improvement of the invention, the substrate is a silicon oxide layer.

As a further improvement of the invention, the material of the strip waveguide and the sub-grating is one or more of silicon and silicon nitride.

The invention provides a subwavelength BIC-based grating. For the grating, the coupling of energy to adjacent gratings can be divided into two parts. One is the coupling effect similar to that of strip waveguides, and the other is the enhanced coupling effect due to the sideward emission of gratings. Therefore, suppressing the sideward emission contributes to suppressing the crosstalk between gratings. The invention uses a subwavelength BIC-based grating to suppress sideward emission, thereby suppressing crosstalk between gratings, reducing the antenna pitch of the OPA, and increasing the phase-tuned beam steering range. BIC provides a new light confinement mechanism for waveguides, one type of which is achieved by controlling interference of radiation modes through parameter tuning. When the number of radiation channels is small, optimizing the grating parameters can suppress the energy coupled into the radiation modes. Such suppression can be explained by the interference effect of two or more radiation modes that cancel each other out. Therefore, BIC-based waveguides can be explained as the destructive interference between multiple radiation channels that eliminates the outward radiation of waves. In summary, the beneficial effects of the invention are as follows: (1) the grating can effectively suppress the sideward emission, eliminates the far-field light spot splitting, and thereby reduces the crosstalk between adjacent gratings and (2) the grating can be manufactured by only one full etching process, which reduces the complexity of the process to ensure compatibility between the design and typical manufacturing processes of silicon optoelectronic foundries and thereby reduces the cost.

### IV. BRIEF DESCRIPTION OF THE DRAWINGS

FIG. 1 is a perspective view of the subwavelength grating of the invention.

FIG. 2 is a front view of the subwavelength grating of the invention.

FIG. 3 is a left view of the subwavelength grating of the invention.

FIG. 4 is a top view of the subwavelength grating provided by the invention.

FIG. 5 is the mode field distribution of the sub-wavelength grating in direction y of the invention.

FIG. 6 is a near-field distribution of 1 mm long sub-wavelength grating of the invention.

FIG. 7 is the schematic of the far-field divergence angle of the 1 mm long sub-wavelength grating of the invention.

FIG. 8 is a near-field distribution of near-field of 1 mm long subwavelength grating with apodization.

FIG. 9 is a three-dimensional schematic diagram of the grating to an embodiment of the invention.

FIG. 10 is a top view of schematic diagram of the grating to an embodiment of the invention.

FIG. 11 is a schematic diagram of the grating radiation to an embodiment of the invention.

FIG. 12 is the comparison diagram of the relationship between the emission of grating and the width w₁ of the strip waveguide to an embodiment of the invention.

FIG. 13 is the far-field schematic diagram of the grating to an embodiment of the invention, with a strip waveguide width of w₁=365 nm.

FIG. 14 is the far-field schematic diagram of the grating to an embodiment of the invention, with a strip waveguide width of w₁=550 nm.

FIG. 15 is a schematic diagram of a two adjacent strip waveguides system.

FIG. 16 is a schematic diagram of a two adjacent subwavelength grating system.

FIG. 17 is the comparison diagram of the crosstalk between two adjacent gratings and two adjacent strip waveguides to an embodiment of the invention.

FIG. 18 shows three-dimensional schematic diagrams of the sub-gratings with different shapes.

FIG. 19 shows the top view of the sub-gratings with different shapes of FIG. 18.

### V. DETAILED DESCRIPTION

The invention will be further explained below in conjunction with the accompanying drawings and specific embodiments.

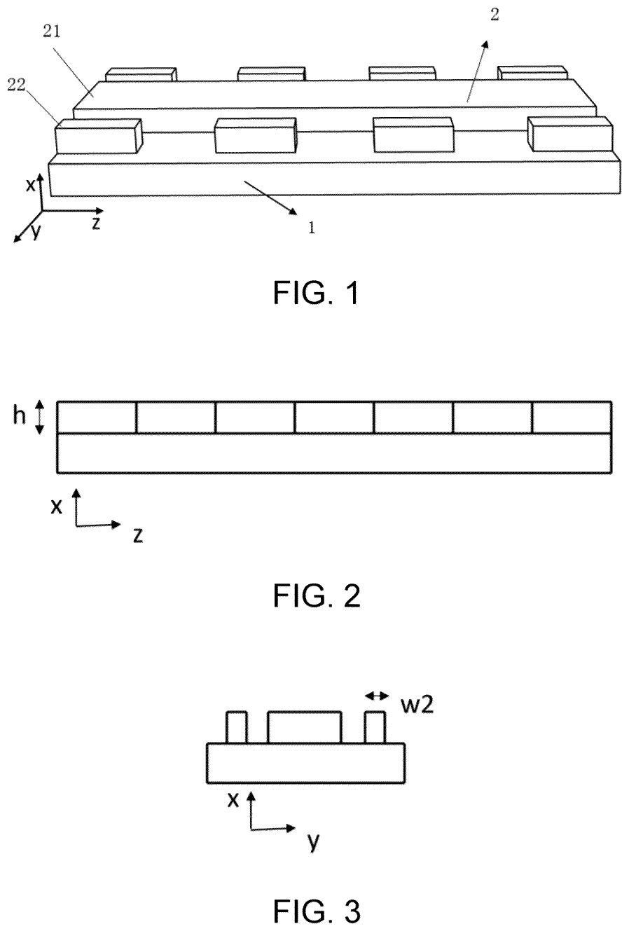

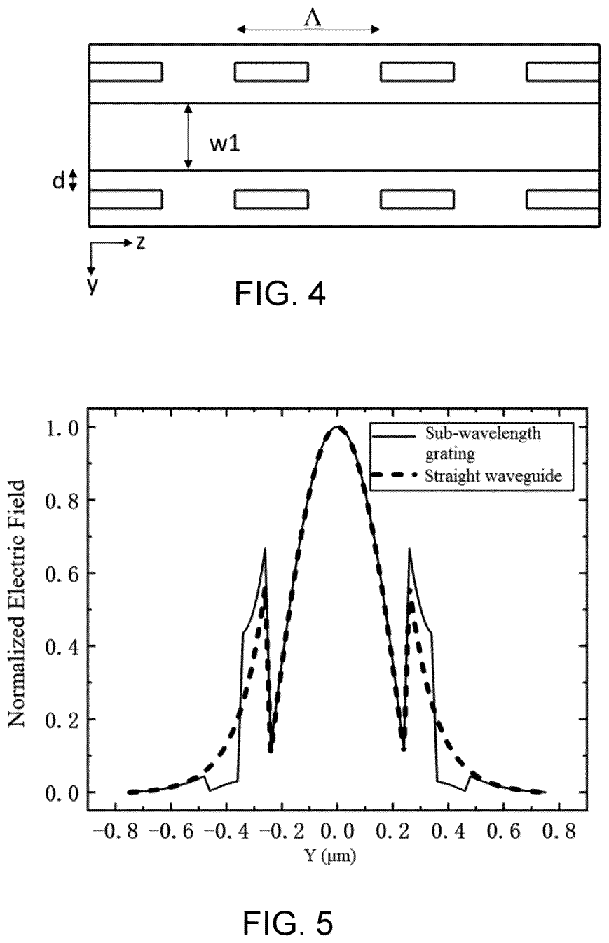

As shown in FIG. 1 to FIG. 4, the subwavelength grating is used to form the optical antenna for optical phased arrays, wherein a bottom layer of the subwavelength grating is an oxide layer with a thickness of 2 μm such as a silicon dioxide layer 1, and a top layer is the subwavelength grating structure 2 made from silicon. A strip waveguide 21 with a width w₁ is disposed in the middle of the subwavelength grating, wherein subwavelength blocks 22 with a width w₂ are periodicity disposed on two sides of the strip waveguide 21 and are at positions spaced apart from the two sides of the strip waveguide 21 by a distance d. The subwavelength grating structure is etched on an SOI (Silicon-on-Insulator) platform (not shown) in such a manner: firstly, the silicon dioxide layer 1 is etched, then the silicon waveguide and subwavelength blocks are etched on the silicon dioxide layer 1, the strip waveguide 21 in the middle of the subwavelength grating structure 2 and the subwavelength blocks 22 on two sides of the straight waveguide 21 have the same thickness, which is 220 nm as shown. So only one standard etching of a depth of 220 nm is required and can be completed in one lithography cycle. Regarding other structures described in the description of the related art, an extra etching process is required for etching other depth which increases the fabrication complexity. As a result, compared with the prior art, the manufacturing process of the structure of this disclosure is relatively simple. The basic principle of decreasing the grating strength in this structure is that the transmission strip waveguide and the grating are separated in the horizontal direction. FIG. 5 is a mode field distribution in direction y. In the mode field distribution diagram, the dash line indicates the field distribution of a strip waveguide without the subwavelength structure, and the black line indicates the mode distribution of the waveguide with the subwavelength grating. As shown in FIG. 5, it can be seen the existence of the subwavelength blocks mainly interact with the evanescent field, resulting in small perturbation strength.

By controlling the positions and sizes of the subwavelength parts, gratings with different effective lengths can be achieved.

The technical effects fulfilled by the grating is introduced below. 1 mm long subwavelength grating is simulated to verify the feasibility of the structure.

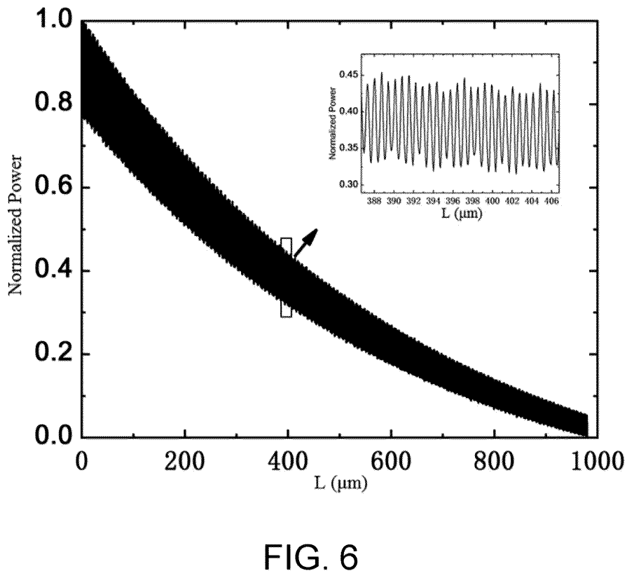

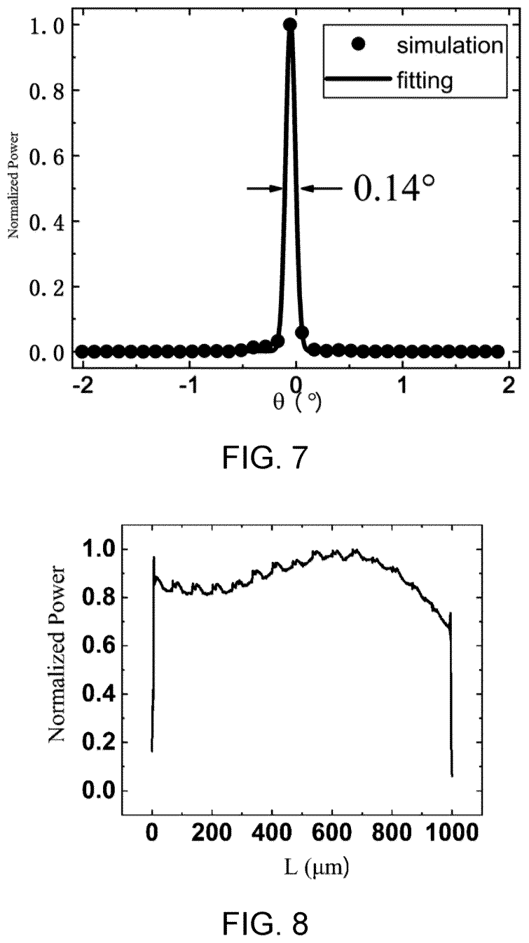

Case 1: the parameters of the grating are set as follows: w1=500 nm, d=100 nm, w2=120 nm, Λ=700 nm, and h=220 nm (the meanings of the parameters are shown in FIG. 2 to FIG. 4), and near-field and far-field distribution of emitted light is simulated. FIG. 6 shows power attenuation in the grating. As shown in FIG. 6, the power decays exponentially and could propagate one millimeter before attenuating to around 10% of its initial power as expected. FIG. 7 shows the far-field divergence angle of the grating in the transmission direction. As shown in FIG. 7, the far-field divergence angle is around 0.14°, which means that after the emitted light is transmitted by 50 m in free space, the spot size is only about 25 cm. To sum up, under the precondition that the feature size of this structure is greater than 100 nm, a millimeter-length grating is realized by means of a simple structure, and the far-field divergence angle is reduced.

Case 2: the parameters of the grating are set as follows: w1=400 nm, d=100 nm, w2=120-350 nm (quadratically varying with the increase of number of periods), Λ=800 nm, and h=220 nm (the meanings of the parameters are shown in FIG. 2 to FIG. 4), and the near-field distribution of the emitted light is shown in FIG. 8. As shown in FIG. 8, the light can be transmitted by 1 mm in the grating and is emitted approximately uniformly.

The subwavelength grating structure provided by the invention can be used as optical antenna for optical phased array and can achieve millimeter-length grating with different light near field distributions. Compared with other long grating structures, the subwavelength grating structure is easier to manufacture, can reduce the far-field divergence angle of the optical phased array and can control the near-field distribution, thus having better application performance in the fields of LiDAR, free-space optical communication, holographic projection and the like.

The subwavelength grating structure provided by the invention has the following advantages:
(1) The structure has a feature size greater than 100 nm and is manufactured through one etching depth, thus being easier to manufacture.
(2) The structure can realize an emission grating with a millimeter-level effective length and greatly reduces the far-field divergence angle.
(3) Different near-field distribution can be realized according to different requirements.

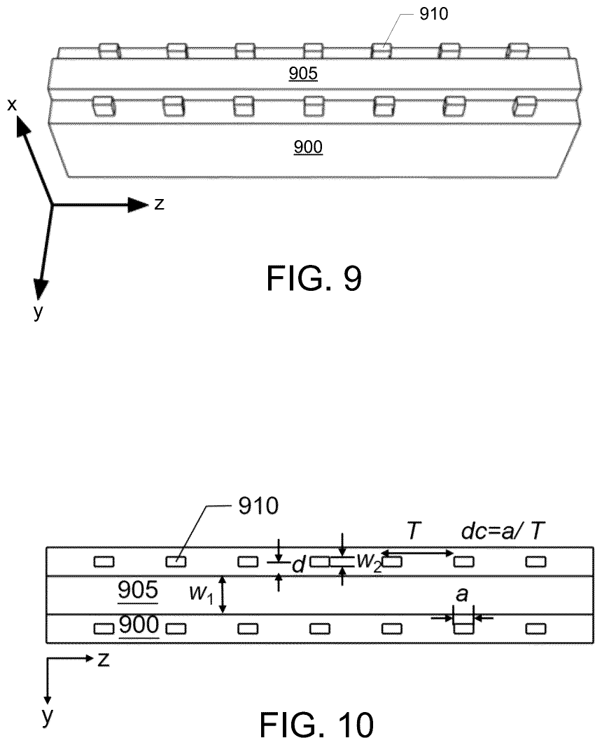

Referring to FIG. 9, the subwavelength BIC-based grating includes a substrate 900 and a grating layer installed on the substrate. The grating layer includes a strip waveguide 905 and a plurality of sub-gratings 910 symmetrically disposed on both sides of the strip waveguide. The sub-gratings, which excite the radiation mode, form destructive interference between the sideward radiation modes by adjusting the width of the strip waveguide, and is used to establish BIC. Referring to FIG. 9, the sub-gratings 910 have a rectangular structure and are periodically arranged. The thicknesses of the sub-gratings and the strip waveguide are the same. Referring to FIG. 10, when the width w₁ of the strip waveguide is from 350 nm to 550 nm, the sideward emission ratio is less than 0.5.

In a preferred embodiment, the substrate 900 is a silicon oxide layer, with a thickness of 2 μm specifically.

In a preferred embodiment, the thickness of the sub-grating 910 and the strip waveguide 905 is 220 nm.

Referring to FIG. 10, in a preferred embodiment, the arrangement period T of the sub-gratings is 800 nm, and the duty cycle dc is 0.3, where dc=a/T and a is the length of the sub-grating.

Referring to FIG. 10, in a preferred embodiment, the distance d between the sub-gratings and the strip waveguide is 100 nm.

Referring to FIG. 10, in a preferred embodiment, the width w₂ of the sub-gratings is 160 nm.

In a preferred embodiment, the material of the strip waveguide and the sub-gratings is one or more of silicon and silicon nitride.

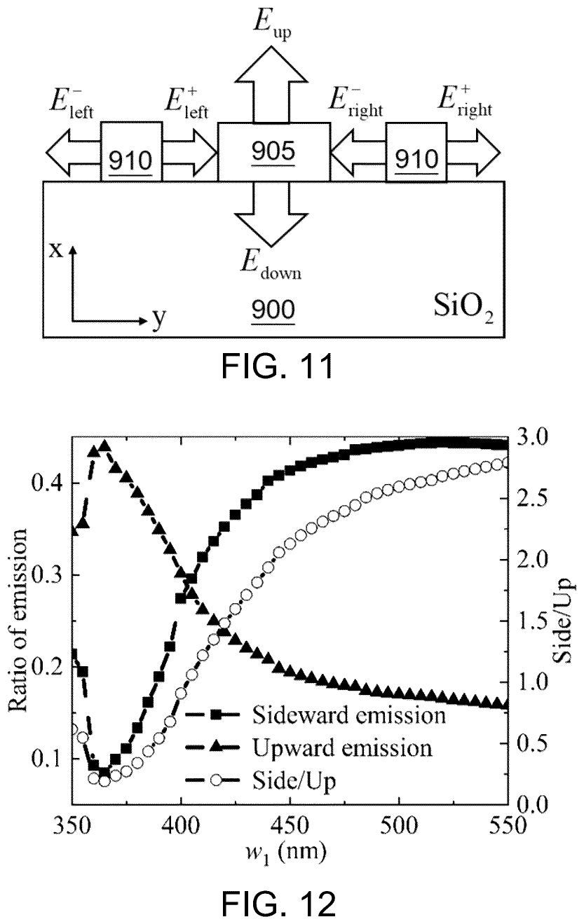

In a preferred embodiment, the width of the strip waveguide cooperates with the sub-grating to excite the radiation modes, and by establishing destructive interference between sideward radiation modes, the sideward emission ratio of the grating is less than 0.1. In the specific implementation process, the lower the sideward emission ratio of the grating, the better the destructive interference effect. Due to the periodic modulation of the subwavelength sub-grating, part of the energy incident into the strip waveguide can be coupled into the radiation modes excited by the sub-grating, including modes radiated to the up, down, left, and right sides. The radiation schematic diagram is shown in FIG. 11, E_{left}^{±} and E_{right}^{±} represent the radiation modes excited by the sub-gratings symmetrically arranged on the left and right sides of the strip waveguide, respectively. “+” represents the rightward radiation mode and “−” represents the leftward radiation mode. By establishing destructive interference between E_{left}^{±} and E_{right}^{±}, the mode is confined inside the grating in the horizontal direction (y-direction), thereby establishing a diffraction-limited BIC. If the input is the TE0 mode, the bound state is the TE0 mode propagating along the interior of the strip waveguide (toward the +z direction), and the continuum is the radiation modes radiating into free space. The establishment of BIC is related to the width of the strip waveguide, the width of the sub-gratings, and the distance between the sub-gratings and the strip waveguide. It is easier to establish BIC by adjusting the width of the strip waveguide. By adjusting the width w₁ of the strip waveguide, the interference between multiple scattering modes along the lateral direction can be controlled. When the conditions for destructive interference are met, the sideward emission of light can be suppressed. In the embodiment, the width of the strip waveguide is continuously adjusted until the sideward emission ratio of the grating is detected to be less than 0.1, which is considered to be a BIC.

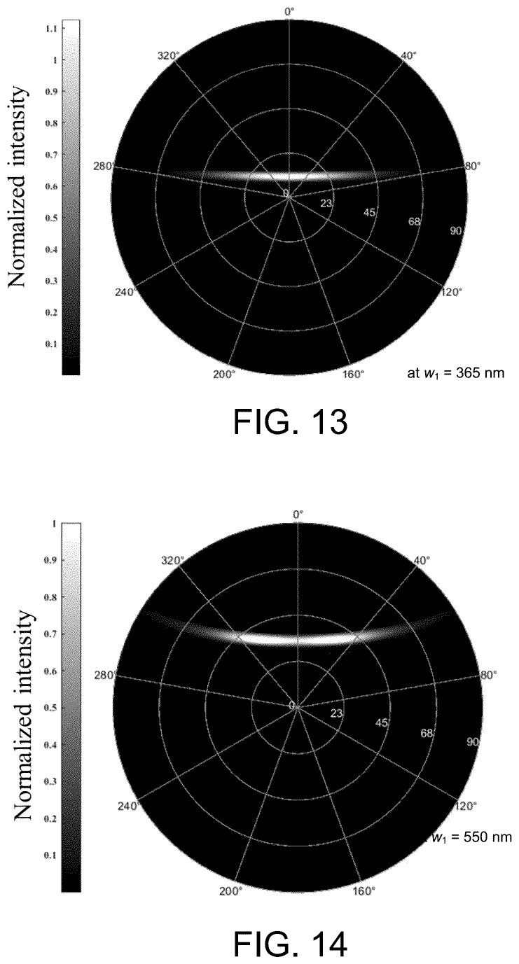

In a specific embodiment of the invention, the grating parameters are set to be, T=800 nm, w₂=160 nm, d=100 nm, and dc=0.3. The variation of emission ratios in various directions of the grating was simulated at 1550 nm, and the results are shown in FIG. 12. It can be seen that the sideward emission ratio varies with w₁. When w₁ is 365 nm, the sideward emission ratio is the lowest, which is less than 0.1, indicating that the sideward emission is effectively suppressed. Referring to FIG. 12, w₁ is set to be 365 nm and 550 nm, respectively, and the far-field of the two gratings are simulated, as shown in FIG. 13 and FIG. 14, respectively. It can be seen that when w₁ is 550 nm, the far-field light spot is split due to strong sideward emission. When w₁ is 365 nm, there is no such phenomenon, which shows that the suppression of sideward emission can prevent the far-field light spot from splitting.

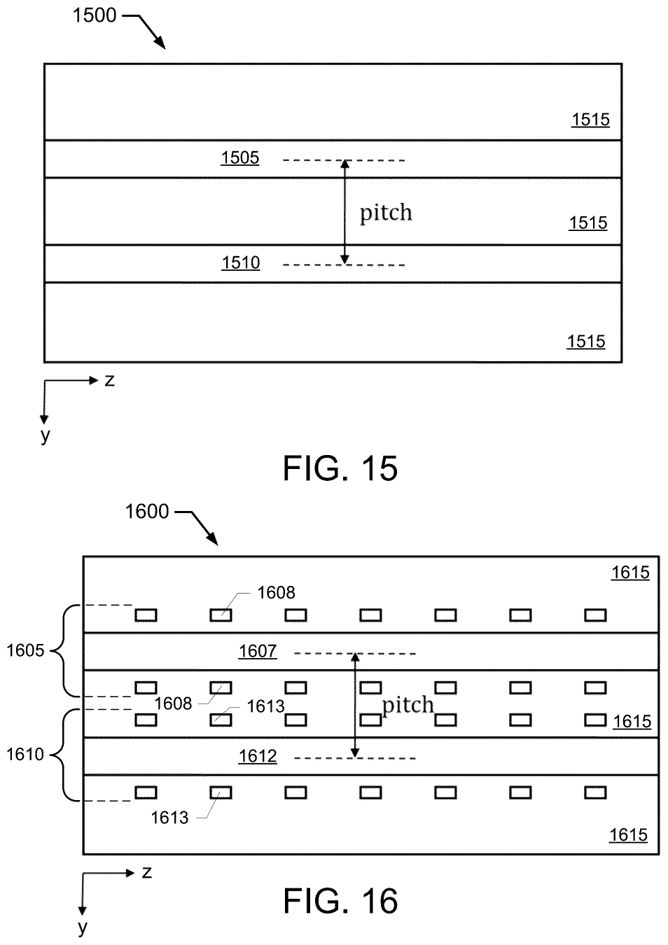

FIG. 15 and FIG. 16, are schematic diagram illustrations of a two adjacent strip waveguide system 1500 and a two adjacent subwavelength grating system 1600, respectively. Referring to FIG. 15, the pitch of the strip waveguide system 1500 refers to the center-to-center distance between a first strip waveguide 1505 and a second adjacent strip waveguide 1510. Each of the strip waveguides are atop a substrate 1515. The crosstalk of the system 1500 is related to the pitch and typically exhibits an inverse proportionality. Referring to FIG. 16, the pitch of the subwavelength grating system 1600 refers to the center-to-center distance between a first subwavelength grating waveguide 1605, comprising a strip waveguide 1607 and a plurality of sub-grating 1608 symmetrically arranged on both sides of the strip waveguide 1607, and a second adjacent subwavelength grating waveguide 1610, comprising a strip waveguide 1612 and a plurality of sub-grating 1613 symmetrically arranged on both sides of the strip waveguide 1612. Each of the subwavelength grating waveguides are atop a substrate 1615. Due to the sideward emission of the gratings, the crosstalk between subwavelength grating waveguides is typically stronger compared to strip waveguides with the same pitch.

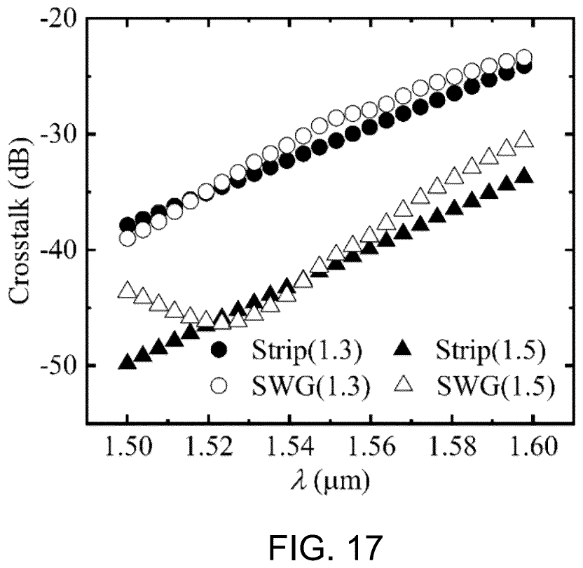

To further verify the crosstalk between BIC gratings, when w₁ is 365 nm, the crosstalk between adjacent gratings from 1500 nm to 1600 nm is simulated, and is compared with the corresponding strip waveguides with the same width of 365 nm. Referring to FIG. 17 which indicates the simulation results, when the grating pitch is 1.3 μm, the crosstalk between the gratings (SWG) and the strip waveguides (Strip) is very close, which means that the coupling effect of the grating sideward emission enhancement is suppressed. When the grating pitch is 1.5 μm, the difference in crosstalk between gratings and strip waveguides at long wavelengths is still very small, but at short wavelengths the crosstalk of BIC gratings (SWG) is significantly larger than that of strip waveguides (Strip). This is because compared to the grating pitch of 1.3 μm, the sideward emission of the grating has a greater impact on coupling, and the suppression of sideward emission at short wavelengths is weak. In summary, the BIC-based subwavelength grating can effectively suppress the sideward emission, thus effectively suppressing the crosstalk between gratings.

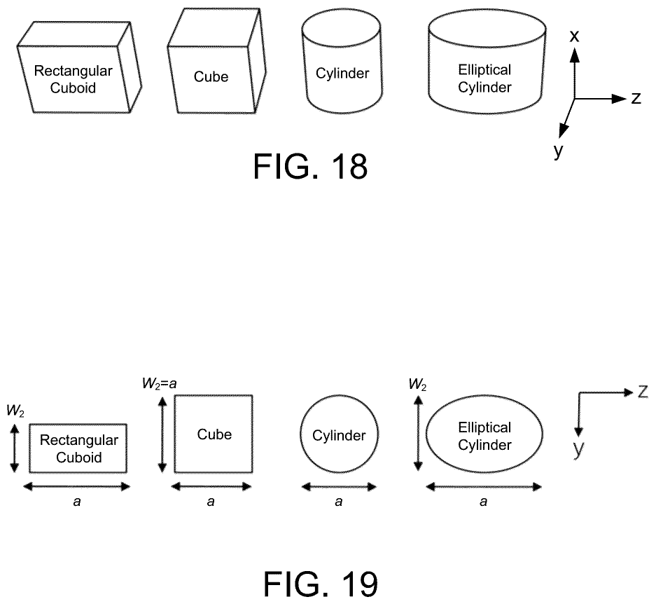

In some embodiments, the three-dimensional shape of the sub-gratings may comprise one or more of a rectangular cuboid, a cube, a cylinder, or an elliptical cylinder as illustrated in FIG. 18 and FIG. 19. FIG. 19 shows the top view of the sub-gratings with different shapes, where a and w₂ represent the dimensions of the sub-gratings in the z-direction and y-direction, respectively. Specifically, for a cylinder, a represents its diameter, while for an elliptical cylinder, a and w₂ represent the length of its major and minor axes, respectively.

In summary, the invention provides a subwavelength BIC-based grating. For the grating, the coupling of energy to adjacent gratings can be divided into two parts. One is the coupling effect similar to that of strip waveguides, and the other is the enhanced coupling effect due to the sideward emission of the grating. Therefore, suppressing the sideward emission contributes to suppressing the crosstalk between gratings. The invention uses a subwavelength BIC-based grating to suppress sideward emission, thereby suppressing crosstalk between gratings, thereby reducing the antenna pitch of the OPA and increasing the phase-tuned beam steering range. BIC provides a new light confinement mechanism for waveguides, one type of which is achieved by controlling interference of radiation modes through parameter tuning. When the number of radiation channels is small, optimizing the grating parameters can suppress the energy coupled into the radiation modes. Such suppression can be explained by the interference effect of two or more radiation modes that cancel each other out. Therefore, BIC-based waveguides can be explained as the destructive interference between multiple radiation channels that eliminates the outward radiation of waves. Ultimately, the grating can effectively suppress the sideward emission, eliminate the far-field light spot splitting, and thereby reduce the crosstalk between adjacent gratings. Additionally, the grating can be manufactured by only one full etching process, which reduces the complexity of the process to ensure compatibility between the design and typical manufacturing processes of silicon optoelectronic foundries and thereby reduces the cost.

In this document, the terms “include,” “comprise,” or any other variations thereof are intended to cover non-exclusive inclusions. Thus, steps and methods that include a series of elements include not only those elements, but also other elements that are not explicitly listed, or elements that are inherent to such steps and methods.

The invention is further expounded above in conjunction with specific preferred embodiments, but the specific implementation of the invention is not limited to the above description. Those ordinarily skilled in the art can make different simple extrapolations or substitutions without departing from the conception of the invention, and all these extrapolations or substitutions should also fall within the protection scope of the invention.

1. A subwavelength grating based on bounds state in the continuum as the optical antenna for optical phased arrays, comprising a substrate and a grating layer atop the substrate,
wherein the grating layer comprises a strip waveguide having a width and a plurality of sub-gratings symmetrically disposed on both sides of the strip waveguide with a gap between edges of the strip waveguide and edges of the sub-gratings and with a periodicity on two sides of the strip waveguide and the periodicity of the sub-gratings are arrayed in a direction along the strip waveguide to form the subwavelength grating, and
wherein the width of the strip guide and the plurality of sub-gratings are configured to excite radiation modes to form destructive interference between sideward radiation modes such that the sideward emission ratio of the subwavelength grating is less than 0.1.

2. A subwavelength grating based on bounds state in the continuum as the optical antenna for optical phased arrays according to claim 1, wherein the plurality of sub-gratings comprises one or more of a cuboid, a cube, a cylinder, or an elliptical cylinder.

3. A subwavelength grating based on bounds state in the continuum as the optical antenna for optical phased arrays according to claim 1, wherein the plurality of sub-gratings are disposed on a different layer from the strip waveguide.

4. A subwavelength grating based on bounds state in the continuum as the optical antenna for optical phased arrays according to claim 1, wherein the thicknesses of the plurality of sub-gratings and the strip waveguide are the same.

5. A subwavelength grating based on bounds state in the continuum as the optical antenna for optical phased arrays according to claim 1, wherein the substrate is a silicon oxide layer.

6. A subwavelength grating based on bounds state in the continuum as the optical antenna for optical phased arrays according to claim 1, wherein the material of the strip waveguide and the plurality of sub-gratings comprises a material, wherein the material comprises one or more of silicon or silicon nitride.
